(19) United States
(12) Patent Application Publication
(10) Pub. No.: US 2011/0181041 A1
(43) Pub. Date: Jul. 28, 2011

(54) Expansion Joint Arrangement

(75) Inventor: Philip B. Argersinger, West Monroe, NY (US)

(73) Assignee: FHC PROPERTIES, LLC, East Syracuse, NY (US)

(21) Appl. No.: 13/049,171

(22) Filed: Mar. 16, 2011

Related U.S. Application Data
(63) Continuation-in-part of application No. 12/017,490, filed on Jan. 22, 2008, now abandoned.

(51) Int. Cl. F16L 27/10

(52) U.S. Cl. 285/223

(57) ABSTRACT

Provision is made to limit the degree of expansion of an expansion joint having a flexible body interposed between a pair of axially spaced flanges. The flanges or radial extensions thereof are interconnected by two or more circumferentially spaced cables, with the cables being unitary in form but having a pair of parallel strands, with the two ends of the cable being interconnected such that the two stands limit the expansion of the joint. The cables can alternatively include two separate circumferentially spaced non-looped cables. Compression of the assembly is limited by way of a sleeve disposed on one strand and adapted to have its ends engage the inner surfaces of the flanges or radial extensions thereof upon reaching the limit of intended compression.

### RELATED APPLICATION DATA

The present application is a continuation in part of U.S. application Ser. No. 12/017,490 filed on Jan. 22, 2008, which is hereby incorporated by reference in its entirety.

### BACKGROUND OF THE INVENTION

1. Field of Invention

This invention relates generally to flexible expansion joints and, more particularly, to a method and apparatus for limiting the axial extension and compression thereof.

2. Description of the Related Art

Expansion joints are commonly installed in piping systems such as those used in the chemical processing industry, and in the air conditioning, heating, plumbing, refrigerating and ventilating fields. The purposes of such a joint are to provide flexibility for accommodating expansion and contraction due to pressure and temperature variations, and for damping vibrations to thereby reduce noise. In the absence of such an expansion joint in a piping or ducting system, the vibrations and the pressure and thermal changes can produce stress on the system at fixed points such as at vessels and rotating equipment, as well as in the piping or ductwork system itself.

Typically, an expansion joint includes a fluid conducting flexible body member secured between a pair of spaced flanges, with the combination then being interposed within a length of pipe or duct. The flexible body member may be in the form of a metal bellows, a Teflon bellows or an elastomeric spherical arch.

Recognizing that under certain conditions, the assembly can be expanded or contracted beyond the allowable limits of safe operation, provision has been made to axially restrain such motion. This has customarily been accomplished by a pair of limit rods that are axially mounted on opposite sides of the joint and connected at their opposite ends to the flanges or to gusset plates attached to and extending radially outwardly from the coupling flanges. Overextension was prevented by fasteners attached to the limit rods on the axially outer sides of the flanges. Compression of the unit was limited by fasteners located on the axially inner sides of the flanges or by way of a pipe sleeve disposed over each of the tie rods.

Because of the rigidity of the tie rods, and the relative inflexibility of the combination during installation within a system, some expansion joints are now being assembled without tie rods but with a flexible link, such as a cable, interconnecting the spaced flanges. One such arrangement is shown in U.S. Pat. No. 5,273,321.

Description of the Related Art Section Disclaimer: To the extent that specific publications/devices/products are discussed above in this Description of the Related Art Section, these discussions should not be taken as an admission that the discussed publications/devices/products are prior art for patent law purposes. For example, some or all of the discussed publications/devices/products may not be sufficiently early in time, may not reflect subject matter developed early enough in time and/or may not be sufficiently enabling so as to amount to prior art for patent law purposes. To the extent that specific publications/devices/products are discussed above in this Description of the Related Art Section (as well as throughout the application), they are all hereby incorporated by reference into this document in their respective entirety(ies).

### SUMMARY OF THE INVENTION

The present invention recognizes that there are potential problems and/or disadvantages in the above-discussed conventional expansion joint assemblies. One of the problems associated with the conventional expansion joint assemblies with tie rods is that the tie rods are rigid and the combination is relatively inflexible during installation within a system, as discussed above. Other problems with conventional expansion joint assemblies with tie rods include (1) the relative weight of these assemblies (as compared to assemblies of the present invention with cables) increases shipping costs, (2) the requirement of field installation knowledge to avoid improper setting for rated axial extension of the expansion joint (which could result in compromising the integrity of the expansion joint), (3) restricting rotational movement of rubber expansion joint floating flanges, and (4) the transmission of vibration induced noise if not properly designed and installed. A problem associated with conventional expansion joint assemblies that include a flexible link, such as a cable, in place of a tie rod interconnecting the spaced flanges is that the flexible links do not prevent the joint from being compressed beyond the allowable limits. Further the need to secure the flexible links/cables to the flanges complicates the process. Various embodiments of the present invention may be advantageous in that they may solve or reduce one or more of the potential problems and/or disadvantages discussed in this paragraph.

It is therefore a principal object and an advantage of the present invention to provide an expansion joint assembly that is flexible for installation purposes, but which is limited in its axial movement in operational conditions of both expansion and contraction.

It is a further object and advantage of the present invention to provide an expansion joint assembly that is easier to install than conventional expansion joint assemblies, has no loose parts, and requires no field adjustments other than making certain connections.

It is an additional object and advantage of the present invention to provide an expansion joint assembly that weighs less than conventional expansion joint assemblies, which reduces shipping and handling costs.

It is another object and advantage of the present invention to provide an expansion joint assembly that minimizes the restriction on the rotational capabilities of spherical rubber expansion joint floating flanges, for example, as compared to conventional expansion joint assemblies.

It is a further object and advantage of the present invention to provide an expansion joint assembly that includes a cable with dampening properties, which helps prevent transmission of vibration and noise from rotational equipment or media flow.

Briefly, in accordance with the foregoing objects and advantages of the present invention, an embodiment of the present invention provides an expansion joint assembly that includes a cable that extends between and is secured to two gussets. The cable can be extended through one opening in each gusset and then back through another opening therein, with the ends being secured together by a single crimping device. Each gusset can be attached to one of two axially spaced flanges by way of a bolt, nut or other fastening means, where the flanges are also secured at opposite ends of a generally cylindrical flexible body disposed therebetween for conducting the flow of fluid therethrough and adapted to be fluidly connected to a pipe structure on either end thereof. The present invention contemplates more than one pair of gussets attached to the pair of axially spaced flanges. In a preferred embodiment, each gusset is secured near the radially outer edge of each respective flange.

In accordance with another embodiment of the present invention, compression of the expansion joint assembly of the first embodiment can be limited by a sleeve which is disposed over one strand of the cable, with the other strand being outside of the sleeve to facilitate the crimping process. The present invention also contemplates an embodiment where an additional sleeve is disposed over the other strand, and an embodiment where a sleeve is disposed over both strands of the cable.

In accordance with an alternative embodiment of the present invention, an expansion joint assembly is provided that includes at least two non-looped cables extending between and secured to two gussets. Each cable can be extended through an opening in each gusset, with the ends of each cable being secured to each respective gusset by way of a bolt, nut, or other fastening means (alternatively, the cables can be secured to each gusset without being extended though an opening in each gusset). Each gusset can be attached to one of two axially spaced flanges by way of a bolt or other fastening means, where the flanges are also secured at opposite ends of a generally cylindrical flexible body disposed therebetween for conducting the flow of fluid therethrough and adapted to be fluidly connected to a pipe structure on either end thereof. The present invention contemplates more than one pair of gussets attached to the pair of axially spaced flanges. In a preferred embodiment, each gusset is secured near the radially outer edge of each respective flange.

In accordance with another embodiment of the present invention, compression of the expansion joint assembly of the alternative embodiment can be limited by a sleeve which is disposed over one cable, with the other cable being outside of the sleeve. The present invention also contemplates an embodiment where an additional sleeve is disposed over the other cable, and an embodiment where one sleeve is disposed over both cables.

In accordance with an embodiment of the present invention, the cables can include pre-stretched break strength certified cable.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

The present invention will be more fully understood and appreciated by reading the following Detailed Description in conjunction with the accompanying drawings, in which:

FIG. 1 is an elevational view of a typical piping installation with expansion joints in accordance with the prior art.

FIG. 2 is a front view, partially in cross section, of an expansion joint in accordance with the prior art.

FIG. 3 is a perspective view of an expansion joint assembly according to an embodiment of the present invention.

FIG. 4 is a perspective view of an expansion joint assembly according to an alternative embodiment of the invention.

FIG. 4a is view of the sleeve and strand partially surrounded by the sleeve shown in FIG. 4 from point A to point B, according to an embodiment of the present invention.

FIG. 5 is a perspective view of an expansion joint assembly according to an alternative embodiment of the invention.

### DETAILED DESCRIPTION

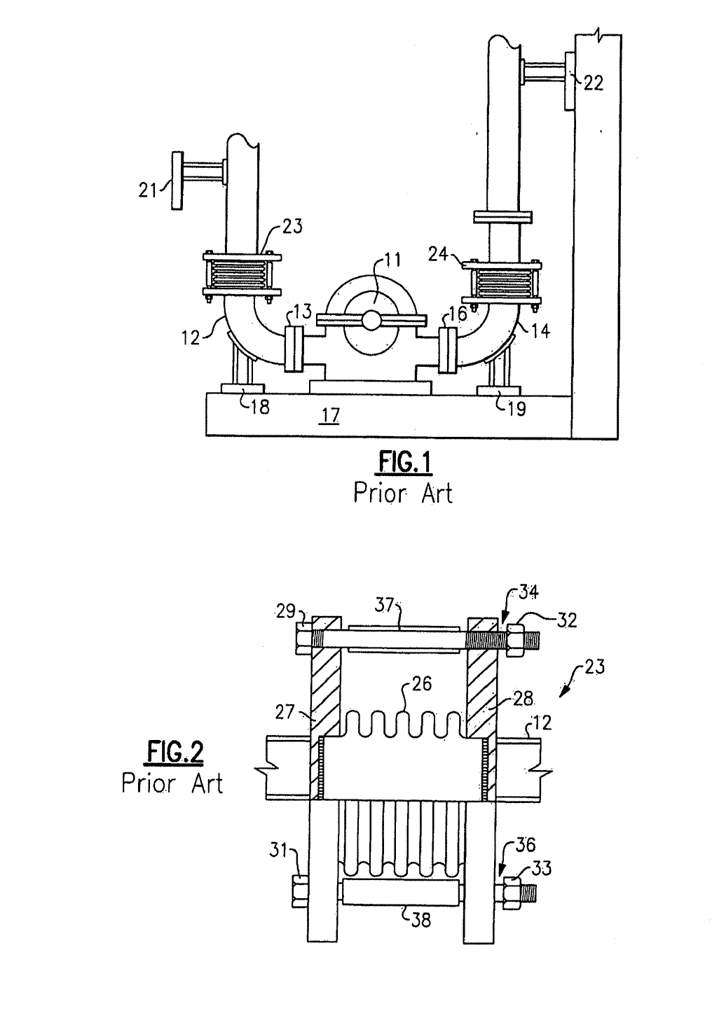

A typical fluid flow pumping and piping arrangement is shown in FIG. 1 which includes a pump 11 fluidly connected to an intake pipe 12 by a flange connection 13 and to a discharge pipe 14 by way of a flange connection 16. The pump 11, although securely fastened to the foundation 17 will tend to transmit some motion to the intake pipe 12 and discharge pipe 14 by vibrations and the like. Support for the piping is provided by way of anchor structures 18 and 19 which are supported by the foundation 17 and by anchor structures 21 and 22 which are securely fastened to vertical support structures within the building.

In addition to the movement as caused by vibrations as discussed hereinabove, thermal and pressure differences will tend to cause the piping system to expand or contract. That is, as the temperature and/or pressure of the fluid being pumped through the system rises, the piping system will tend to expand, and as they are lowered, the piping system will contract. To accommodate that expansion and contraction, a pair of expansion joints 23 and 24 are installed within the piping system, on either side of the pump 11. The structure of the expansion joints 23 and 24 is set forth in more detail in FIG. 2.

Fluidly interconnected between sections of pipe 12 is a fluid conducting flexible body member 26 with appropriate end fittings to match the adjoining pipe fittings. The particular member as shown is a so called bellows design which is formed as a thin walled tubing to form a corrugated cylinder with a plurality of convolutions as shown. Such a member is commonly made from metal (e.g. stainless steel) or Teflon, for example.

The present invention is also applicable to other types of expansion joints. For example, one type of flexible joint commonly used with plastic piping systems is not bellows shaped as shown but rather is formed of a molded spherical flowing arch that is made from an elstomeric material. Although different in structure, these expansion joints also require some type of structure to limit the expansion and contraction of the joint.

The flexible body member 26 is disposed between and connected to a pair of axially spaced flanges 27 and 28 with the interconnection between the flexible body member 26 and the flanges 28 being such that, as the body member 26 expands or contracts, the flanges 27 and 28 are accordingly caused to move toward or away from each other.

Disposed near the radially outer edges of the flanges 27 and 28 are a pair of radially, circumferentially spaced axially disposed tie rod pins 29 and 31 and their associated nuts 32 and 33. The tie rods pins 29 and 31 pass through holes formed in the respective flanges 27 and 28 and the respective nuts 32 and 33 are so positioned on the respective pins 29 and 31, such that clearance spaces 34 and 36 allow for some axial (i.e. outward) movement of the flange 28 but limit the extent to which this can occur. This distance can be selectively adjusted to meet the requirements of the particular expansion joint and application.

In order to limit the movement of the flanges 27 and 28 toward each other, and therefore limit the compression of the expansion joint, a pair of nuts, similar to the nuts 32 and 33, can be selectively placed on the inner sides of the respective flanges 27 and 28. Another approach is to place a pair of sleeves 37 and 38 over the respective tie rods pins 29 and 31 as shown, with the lengths of the sleeves 37 and 38 being generally shorter than the distance between the two flanges 27 and 28. In this way, the flanges 27 and 28 are free to move inwardly, toward each other, to thereby allow for contraction of the body member 26 but this movement is limited when the inner surfaces of the flanges 27 and 28 begin to impinge on the ends of the sleeves 37 and 38.

A variation of the FIG. 2 approach is to provide for two or more radially outwardly extending gussets to be attached to the flanges 27 and 28 and, rather than extending the pins 29 and 31 through the flanges 27 and 28, extending the pins 29 and 31 through openings in the gussets.

Use of tie rod pins 29 and 31 as discussed hereinabove is problematic in some situations. For example, since the tie rod pins are installed on the assembly at the factory and shipped to the site for installation, even though the pins 29 and 31 and their associated nuts 32 and 33 are not adjusted to their final position, the assembly is very rigid in nature and presents difficulties in the process of aligning the expansion joint and securing it in its installed position between two pipe sections. Further, there is often very little space in which to work such that final adjustments and the selective positioning of the nuts 32 and 33 can be difficult.

Referring now to FIG. 3, a pair of axially spaced flanges 39 and 41 are partially shown with radially outwardly extending gussets 42 and 43 attached thereto. The gussets 42 and 43 are secured by way of a plurality of bolts 44 passing through openings 46. For illustrative purposes, the gusset 42 is shown to be installed on the inner side of the flange 39, and the gusset 43 is shown to be attached on the outer side of the flange 41. Although this is a possible arrangement, a more likely installation would be for the two gussets to be on the inner sides of their respective flanges or on the outer sides thereof.

Near the radially outer end of the gusset 42 is a pair of spaced holes 47 and 48. Similarly, near the radially outer end of the gusset 43 is a pair of spaced holes 49 and 51. These holes are used for attachment purposes.

Rather than the use of tie rod pins, the gussets 42 and 43 are interconnected by a cable 52 having two strands 53 and 54. The first strand 53 passes into holes 48 and 51, wraps around the outer surfaces of the respective gussets 42 and 43, and then comes back through holes 47 and 49. The second strand 54 results from the two ends being fastened together by one or more fastening devices 56 such as a crimping device. The result is a double stranded cable which is easy to install either at the factory or on the installation site and which functions to limit the axial separation of the two flanges 39 and 41, and thus the expansion of the expansion joint.

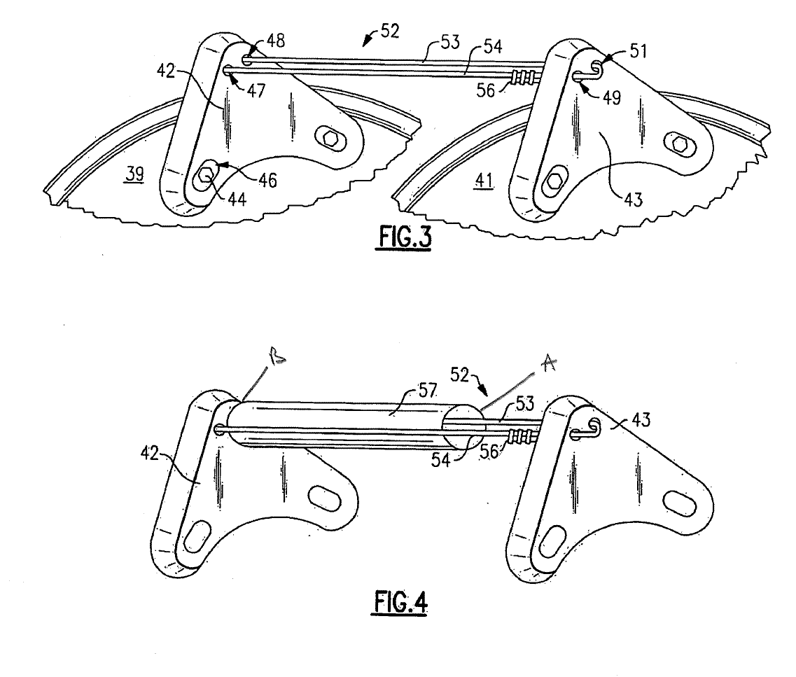

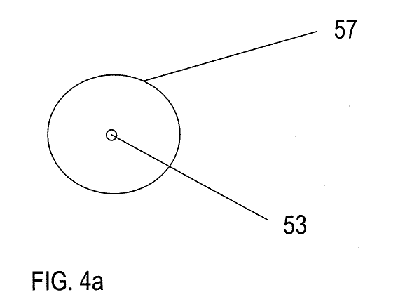

As will be understood, the FIG. 3 embodiment does not provide any protection against over compression of the system. Accordingly, the FIG. 4 embodiment is substantially the same except that a sleeve 57 is disposed over the strand 53 such that in a non-compressed condition, there is a space between the one end of the sleeve 57 and the inner side of the gusset 43. When compression occurs, the two gussets 42 and 43 tend to be moved toward each other, but that movement is limited when the ends of the sleeve 57 become engaged with the inner sides of the gussets 42 and 43. Such an arrangement allows for the strand 54 to be freely accessible for purposes of joining the two ends of the cable 52 for the purpose of installing the crimping device 56.

Turning to FIG. 4a, a view of the sleeve 57 and the strand 53 partially surrounded by the sleeve 57 shown in FIG. 4 from point A to point B is shown, according to an embodiment of the present invention. This view shows that the sleeve can be disposed concentrically around one strand 53 of the cable 52.

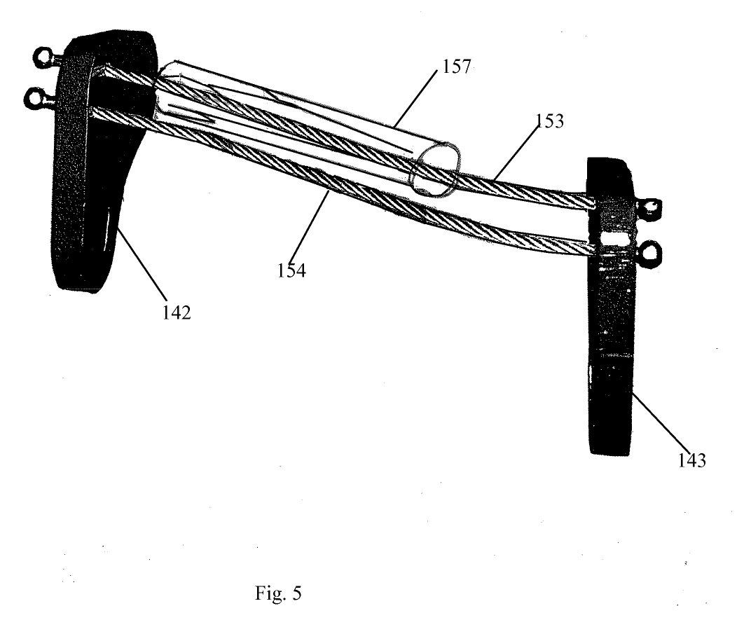

Turning to FIG. 5, a perspective view of an expansion joint assembly is shown according to an alternative embodiment of the invention. The embodiment shown in FIG. 5 is substantially the same as the embodiments shown in FIGS. 3 and 4, except that this embodiment includes at least two non-looped cables 153 and 154 extending between and secured to two gussets 142 and 143. The ends of each of the cables pass through separate holes in gussets 142 and 143, and are secured to the gussets by a fastening means (e.g., nut or bolt). A sleeve 157 is shown disposed over the strand 153 such that in a non-compressed condition, there is a space between the one end of the sleeve 157 and the inner side of the gusset 143. When compression occurs, the two gussets 142 and 143 tend to be moved toward each other, but that movement is limited when the ends of the sleeve 157 become engaged with the inner sides of the gussets 142 and 143. The axially spaced flanges 39 and 41, are not shown, but are contemplated as being similar to the disclosure as described with reference to FIG. 3.

While the present invention has been particularly shown and described with reference to preferred and modified embodiments as illustrated by the drawings, it will be understood by one skilled in the art that various changes in detail may be made thereto without departing from the spirit and scope of the invention as defined by the claims.

We claim:

1. An expansion joint assembly comprising:
a generally cylindrical flexible body for conducting the flow of fluid therethrough and adapted to be fluidly connected to a pipe structure on either end thereof;
a pair of axially spaced flanges secured at opposite ends of said flexible body so as to be axially moved toward or away from each other as said flexible body is axially contracted or expanded, respectively;
at least two circumferentially spaced cables being attached to, and extending between, said pair of flanges, each of said cables being unitary in form but having two parallel strands, and with two ends of the cable being interconnected; and
a rigid sleeve disposed around one strand and having an axial length such that when said flexible body is compressed to a predetermined degree, the ends of the sleeve will engage the respective inner sides of said flanges so as to limit further contraction.

2. An expansion joint assembly comprising:
a generally cylindrical flexible body for conducting the flow of fluid therethrough and adapted to be fluidly connected to a pipe structure on either end thereof;
a pair of axially spaced flanges secured at opposite ends of said flexible body so as to be axially moved toward or away from each other as said flexible body is axially contracted or expanded, respectively;
at least two separate circumferentially spaced non-looped cables being attached to, and extending between, said pair of flanges; and
a rigid sleeve disposed around one non-looped cable and having an axial length such that when said flexible body is compressed to a predetermined degree, the ends of the sleeve will engage the respective inner sides of said flanges so as to limit further contraction.
